(19) United States
(12) Patent Application Publication
(10) Pub. No.: US 2016/0026951 A1
(43) Pub. Date: Jan. 28, 2016

(54) MATURE PRACTICE ASSESSMENT FRAMEWORK

(71) Applicant: Bank of America Corporation, Charlotte, NC (US)

(72) Inventors: Kalyanasundaram Ramanathan, Adyar (IN); Ananya Gopalan, Manikonda (IN); Phani Gautham Tenneti, Kapra Secunderabad (IN); Sonia Verma, Hyderabad (IN); Manish Jaiswal, Medak (IN); Vishal Sharma, New Delhi (IN); Sriram Mahalingam, Ramapuram (IN); Amit Koul, Shaikpethdarga (IN); Amardeep Singh Talwar, New Delhi (IN)

(21) Appl. No.: 14/341,431

(22) Filed: Jul. 25, 2014

(51) Int. Cl. G06Q 10/06

(52) U.S. Cl. CPC G06Q 10/0639

(57) ABSTRACT

Systems, apparatus, and computer program products are presented that provide for assessing technology-related business project maturity across various change platforms, otherwise referred to as change types. Embodiments of the invention herein disclosed take into account both qualitative and quantitative analysis of practices within each business practice to result in a current state assessment of the project's maturity level. In this regard, embodiments of the invention leverage both industry best practices and internal (i.e., business/enterprise) as a means of assessing project maturity. Additionally opportunities for improving maturity and/or driving project efficiency are identified and exemplary practices may also be identified.

### FIELD

In general, embodiments of the invention relate to business management and, more particularly, assessing the maturity of a technology-based business practice.

### BACKGROUND

In the business environment, specifically the technology area, there are many platforms for implementing change. Many of these change platforms are computer-based systems which provide for requirements and solutions to evolve through collaboration amongst change-implementing team members. These change platforms, otherwise referred to as change types, promote adaptive planning, evolutionary development and project delivery through an iterative approach that encourages rapid and flexible response to the change being implemented.

Within a given change platform many different practices exist, such as development practices, testing practices, maintenance practices, production support practices and the like. However, while each different change platform may have a means for assessing such practices, currently no framework exists that provides for assessing such practices across all changes platform.

Therefore, a need exists to develop systems, apparatus, methods, computer program products and the like that provide for assessing a technology project regardless of the change platform, i.e., change type, implemented. The assessment should implement both quantitative (i.e., objective analysis) and qualitative (i.e., subjective analysis) measures to gauge the maturity level of a technology project. In this regard the desired assessment framework should assess the practices implemented within each change platform based on industry best practices, as well as the best practices of the business/enterprise that is undergoing change. In addition the desired methodology should identify opportunities to drive efficiency (i.e., improve project maturity) through planning for future actions and the like. Moreover, the desired systems and the like should identify what practices are industry and/or internal leaders, such that these practices can be leveraged across the industry or business/enterprise.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, methods, computer program products or the like for assessing technological project maturity across various change platforms, otherwise referred to as change types. Embodiments of the invention herein disclosed take into account both qualitative and quantitative analysis of practices within each change platform to result in a current state assessment of the project's maturity level. In this regard, embodiments of the invention leverage both industry best practices and internal (i.e., business/enterprise) as a means of assessing project maturity. In addition, embodiments of the invention, identify opportunities for improving maturity and/or driving project efficiency and also identify those practices that are exemplary.

In specific embodiments of the invention, the methods herein disclosed provide for a maturity assessment framework that calculates a maturity level (e.g., basic, intermediate, advanced) for each of the practices within a change platform and, additionally, calculates metrics performance for each of the practices. As a result of the maturity level calculation for each practice, embodiments of the invention, provide for an overall maturity level/score, which assesses the current maturity of the technology-based change project.

An apparatus for assessing the maturity of a technology-related project defines first embodiments of the invention. The apparatus includes a computing platform having a memory and at least one processor in communication with the memory. In addition, the apparatus includes a project maturity assessment module that is stored in the memory, executable by the processor and configured to receive a first user-input that selects one of a plurality of project types for a project undergoing maturity assessment and, in response to receiving the first user-input, provide display of (i) a plurality of qualitative practice assessment parameters associated with the selected project type and (ii) a plurality of quantitative practice assessment parameters associated with the selected project type. In addition, the module is configured to receive a plurality of second user-inputs that select an assessment level for a corresponding one of the qualitative practice assessment parameters and a plurality of third user-inputs that indicate a quantitative response to a corresponding one of the quantitative practice assessment parameters. The module is further configured to determine quantitative performance metrics for the project based on the quantitative responses to the quantitative practice assessment parameters, and determine a project maturity score based on the quantitative performance metrics and the assessment levels for the qualitative practice assessment parameters.

In accordance with specific embodiments of the apparatus, the project maturity assessment module is further configured to provide display of the plurality of qualitative practice assessment parameters, wherein each qualitative practice assessment parameter is assigned to one of a plurality of qualitative maturity categories including a basic category (i.e., parameters that are required by the project), an intermediate category (i.e., parameters that are a goal of the project) and an advanced category (i.e., parameters that may optionally be adopted by the project).

In further specific embodiments of the apparatus, the project maturity assessment module is further configured to receive the plurality of second user-inputs that select the assessment level as one of (i) fully-implemented, (ii) not fully-implemented or (iii) not applicable to the project. In such embodiments of the apparatus, the project maturity assessment module may be further configured to determine a percentage of fully-implemented qualitative practice assessment parameters for each of the qualitative maturity categories. Moreover, in such embodiments of the apparatus, the project maturity assessment module may be further configured to determine a quantitative maturity category for each of the performance metrics, such as a basic category, an intermediate category and an advanced category, with each category being defined by thresholds applicable to the corresponding performance metric. In such embodiments of the apparatus, the project maturity assessment module may be further configured to determine a percentage of performance metrics currently determined to be residing in each of the maturity categories. In additional specific embodiments of the apparatus, the project maturity assessment module is further configured to determine the project maturity score based on (1) the percentage of fully-implemented qualitative practice assessment parameters for each of the qualitative maturity categories, and (2) a percentage of performance metrics currently determined to be residing in each of the quantitative maturity categories.

In still further specific embodiments of the apparatus, the project maturity assessment module is further configured to generate and provide a dashboard display that includes a plurality of (1) performance metric results, (2) a percentage of performance metrics currently determined to be residing in each of the quantitative maturity categories, (3) a percentage of fully-implemented qualitative practice assessment parameters for each of the qualitative maturity categories, (4) a maturity score for each overall maturity category, (5) an overall maturity score, and (6) a graphical representation of the current maturity score for each overall maturity category and a targeted maturity score for each overall maturity category.

A method for assessing the maturity of a technology-related project defines second embodiments of the invention. The method includes, receiving, by a computing device processor, a first user-input that selects one of a plurality of project types for a project undergoing maturity assessment and, in response to receiving the first user-input, providing, by a computing device processor, display of (a) a plurality of qualitative practice assessment parameters associated with the selected project type and (b) a plurality of quantitative practice assessment parameters associated with the selected project type. The method further includes receiving, by a computing device processor, (a) a plurality of second user-inputs that select an assessment level for a corresponding one of the qualitative practice assessment parameters and (b) a plurality of third user-inputs that indicate a quantitative response to a corresponding one of the quantitative practice assessment parameters. Additionally, the method includes determining, by a computing device processor, quantitative performance metrics for the project based on the quantitative responses to the quantitative practice assessment parameters and determining, by a computing device processor, a project maturity score based on the quantitative performance metrics and the assessment levels for the qualitative practice assessment parameters.

In specific embodiments of the method, providing display of the plurality of qualitative practice assessment parameters further includes providing display of the plurality of qualitative practice assessment parameters, wherein each qualitative practice assessment parameter is assigned to one of a plurality of qualitative maturity categories including a basic category (i.e., parameters that are required by the project), an intermediate category (i.e., parameters that are a goal of the project) and an advanced category (i.e., parameters that may optionally be adopted by the project).

In further specific embodiments of the method, receiving the plurality of second user-inputs that select the assessment level further includes receiving, by the computing device processor, the plurality of second user-inputs that select the assessment level as one of (i) fully-implemented, (ii) not fully-implemented or (iii) not applicable to the project. In such embodiments of the method, determining the project maturity score further includes determining, by a computing device processor, a percentage of fully-implemented qualitative practice assessment parameters for each of the qualitative maturity categories. Moreover, in such embodiments of the method, determining the project maturity score may further include determining, by a computing device processor, a quantitative maturity category for each of the performance metrics, such that the quantitative maturity categories include a basic category, intermediate category and advanced category, with each category being defined by thresholds applicable to the corresponding performance metric. Additionally, in such embodiments of the method, determining the project maturity score may further include determining, by a computing device processor, a percentage of performance metrics currently determined to be residing in each of the maturity categories and determining the project maturity score may further include determining, by a computing device processor, the project maturity score based on (1) the percentage of fully-implemented qualitative practice assessment parameters for each of the qualitative maturity categories, and (2) a percentage of performance metrics currently determined to be residing in each of the quantitative maturity categories.

In still other specific embodiments the method includes generating and providing, by a computing device processor, a dashboard display that includes a plurality of (1) performance metric results, (2) a percentage of performance metrics currently determined to be residing in each of the quantitative maturity categories, (3) a percentage of fully-implemented qualitative practice assessment parameters for each of the qualitative maturity categories, (4) a maturity score for each overall maturity category, (5) an overall maturity score and (6) a graphical representation of the current maturity score for each overall maturity category and a targeted maturity score for each overall maturity category.

A computer program product comprising a non-transitory computer-readable medium defines third embodiments of the invention. The computer-readable medium includes a first set of codes for causing a computer to receive a first user-input that selects one of a plurality of project types for a project undergoing maturity assessment and a second set of codes for causing a computer to, in response to receiving the first user-input, provide display of (1) a plurality of qualitative practice assessment parameters associated with the selected project type and (2) a plurality of quantitative practice assessment parameters associated with the selected project type. Additionally, the computer-readable medium includes a third set of codes for causing a computer to receive (1) a plurality of second user-inputs that select an assessment level for a corresponding one of the qualitative practice assessment parameters and (2) a plurality of third user-inputs that indicate a quantitative response to a corresponding one of the quantitative practice assessment parameters. Moreover, the computer-readable medium includes a fourth set of codes for causing a computer to determine quantitative performance metrics for the project based on the quantitative responses to the quantitative practice assessment parameters, and a fifth set of codes for causing a computer to determine a project maturity score based on the quantitative performance metrics and the assessment levels for the qualitative practice assessment parameters.

Thus, systems, apparatus, methods, and computer program products herein described in detail below provide for assessing technological project maturity across various change platforms, otherwise referred to as change types. Embodiments of the invention herein disclosed take into account both qualitative and quantitative analysis of practices within each change platform to result in a current state assessment of the project's maturity level. In this regard, embodiments of the invention leverage both industry best practices and internal (i.e., business/enterprise) as a means of assessing project maturity.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured for assessing the maturity of a technology-related business project, in accordance with embodiments of the present invention;

FIG. 2 provides a more detailed block diagram of an apparatus configured for assessing the maturity of a technology-related business project highlight alternate embodiments features, in accordance with embodiments of the present invention;

FIG. 3 provides a block diagram of an apparatus configured for assessing the maturity of a technology-related business project highlighting the dashboard user-interface feature, in accordance with present embodiments of the invention;

FIG. 4 provides a flow diagram of a method for assessing the maturity of a technology-related business project, in accordance with embodiments of the present invention;

FIG. 5 provides a user-interface for initiating a technology-related business project maturity assessment, in accordance with present embodiments of the invention;

FIGS. 6A and 6B provide a user-interface for displaying qualitative and quantitative practice assessment parameters, in accordance with embodiments of the present invention;

FIG. 7 provides a user-interface for displaying a project maturity dashboard, in accordance with embodiments of the present invention;

FIG. 8 provides a user-interface of displaying formulas for calculating quantitative performance metrics and related maturity level categorization thresholds, in accordance with embodiments of the present invention; and

FIG. 9 provides a user-interface for displaying corrective action planning resulting from a maturity assessment, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for assessing technology-related project maturity across any and all change platforms, otherwise referred to as change types. Embodiments of the invention herein disclosed take into account both qualitative and quantitative analysis of practices within each change platform to result in a current state assessment of the project's maturity level. In this regard, embodiments of the invention leverage both industry best practices and internal (i.e., business/enterprise) as a means of assessing project maturity. In addition, embodiments of the invention, identify opportunities for improving maturity and/or driving project efficiency and also identify those practices that are exemplary.

In specific embodiments of the invention, the methods herein disclosed provide for a maturity assessment framework that calculates a maturity level (e.g., basic, intermediate, advanced) for each of the practices within a change platform and, additionally, calculates metrics performance for each of the practices. As a result of the maturity level calculation for each practice, embodiments of the invention, provide for an overall maturity level/score, which assesses the current maturity of the technology-based change project.

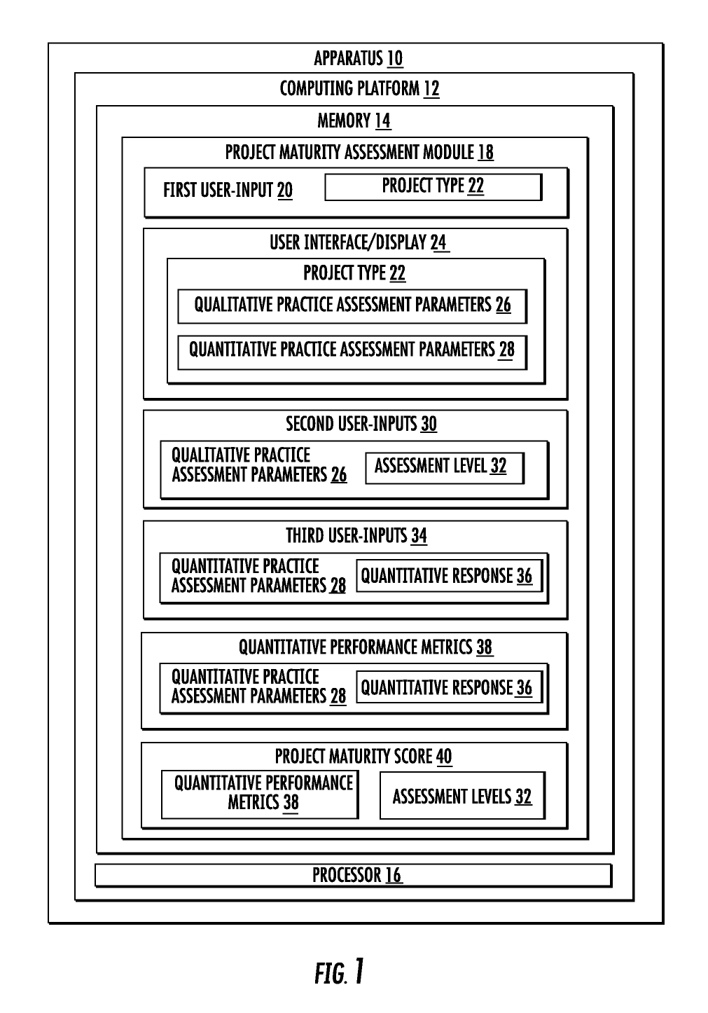

Referring to FIG. 1, a block diagram is presented of an apparatus 10 configured for assessing technology-related project maturity, in accordance with embodiments of the present invention. The apparatus includes a computing platform 12 having a memory 14 and at least one processor 16 in communication with the memory. The memory 14 of apparatus 10 stores project maturity assessment module 18 that is executable by the processor 16 and configured to assess the maturity of technology-related business projects across multiple different business platforms.

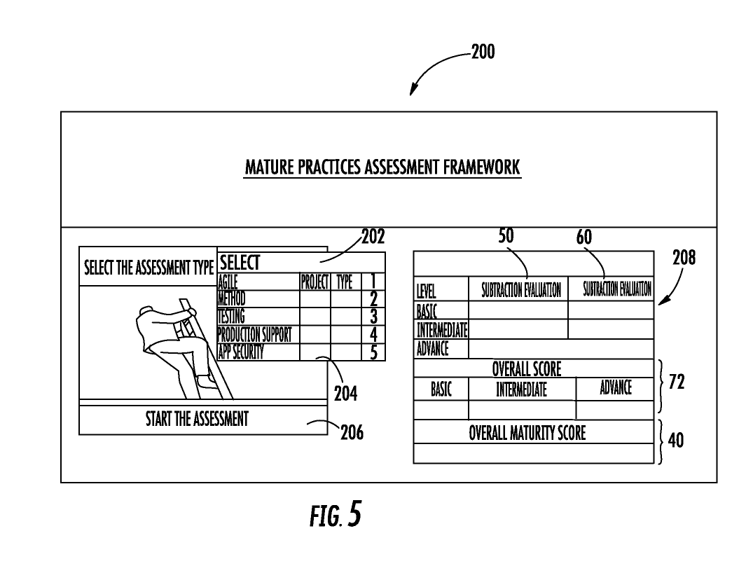

As such, project maturity assessment module 18 is configured receive a first user-input 20 that selects a project type 22, which may be a change platform, change type or the like. Examples of project types include, but are not limited to, incremental software development (e.g., agile software development), sequential design process (e.g., waterfall model), testing, production support, application security and the like. See FIG. 5, and the related discussion, for an illustration of a user-interface configured to receive a user selection of a project type 22.

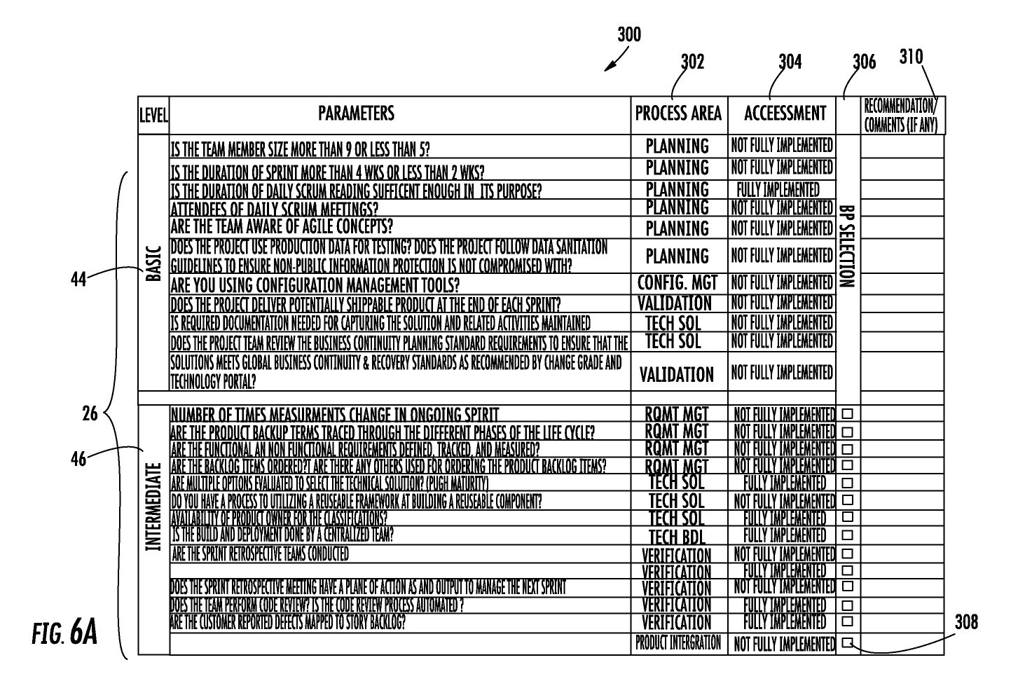

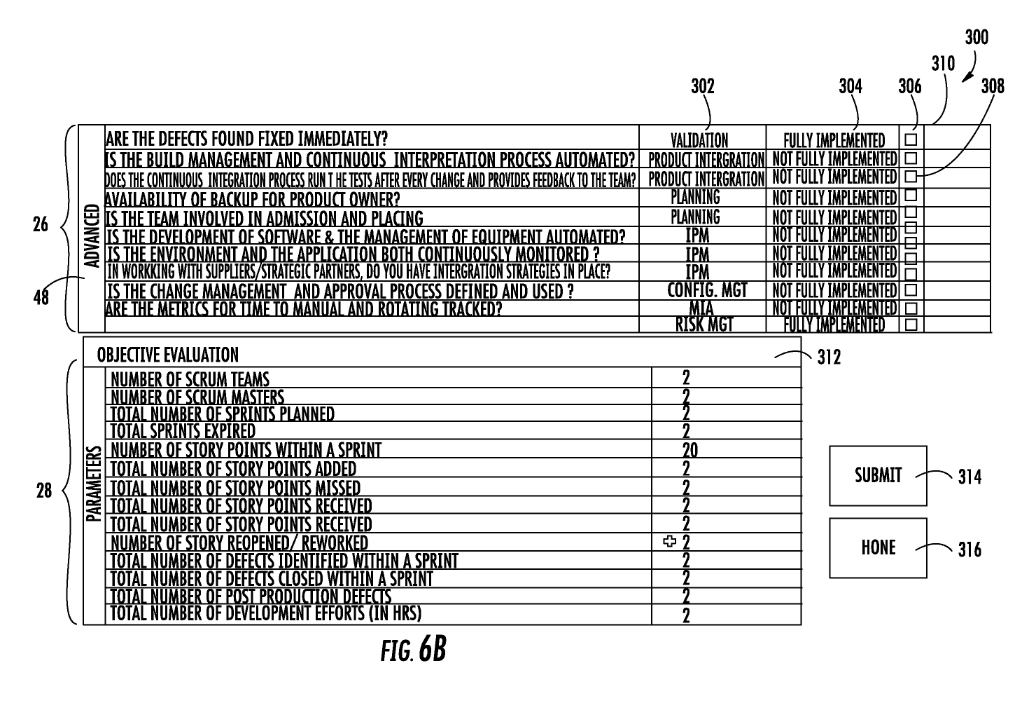

In response to receiving the first-user input 20, the project maturity assessment module 18 is further configured to provide a user-interface/display 24 that includes a plurality qualitative (i.e., subjective) practice assessment parameters 26 associated with the selected project type 22 and a plurality of quantitative (i.e., objective) practice assessment parameters 28 associated with the selected project type 22. In specific embodiments of the invention the qualitative practice assessment parameters 26 may be grouped according to maturity categories, such as a basic category (defined as parameters that required by the project), an intermediate category (defined as parameters that a goal of the project) and an advanced category (defined as parameters that may be optionally adopted by a project). See FIGS. 6A and 6B, and the related discussion, for an illustration of a user-interface 24 configured to present practice assessment parameters 26 and quantitative practice assessment parameters 28.

The project maturity assessment module 18 is further configured to receive second user-inputs 30 that select an assessment level 32 for each of the qualitative practice assessment parameters 26 displayed in user-interface 24. In specific examples of the invention, the assessment levels may include, but may not be limited to, (i) fully implemented, (ii) not fully-implemented, or (iii) not applicable to the project.

In addition, the project maturity module 18 is further configured to receive third user-inputs 34 (or import from predetermined databases) that select a quantitative response 36 for each of the quantitative practice assessment parameters 26. In response to receiving the third user-inputs 34 that select the quantitative responses 36 to the quantitative practice assessment parameters 26, the project maturity assessment module is configured to determine a plurality of quantitative performance metrics 38 that are specific to the project type.

Moreover, in response to receiving the second and third user-inputs and determining the quantitative performance metrics, the project maturity assessment module is configured to determine an overall project maturity score 40 based on the quantitative performance metrics 38 and the qualitative assessment levels 32. The overall maturity score 40 may be configured to indicate a category of maturity (e.g., basic, intermediate, advanced or the like) based on thresholds preconfigured for the quantitative performance metrics 38 and the qualitative assessment levels 32.

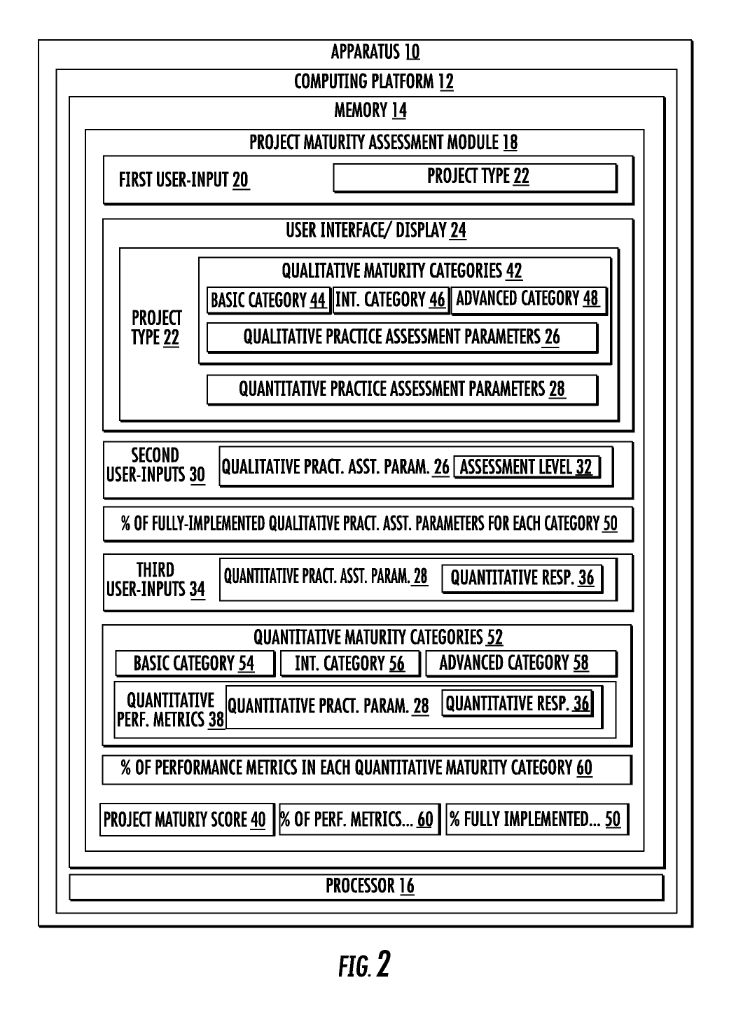

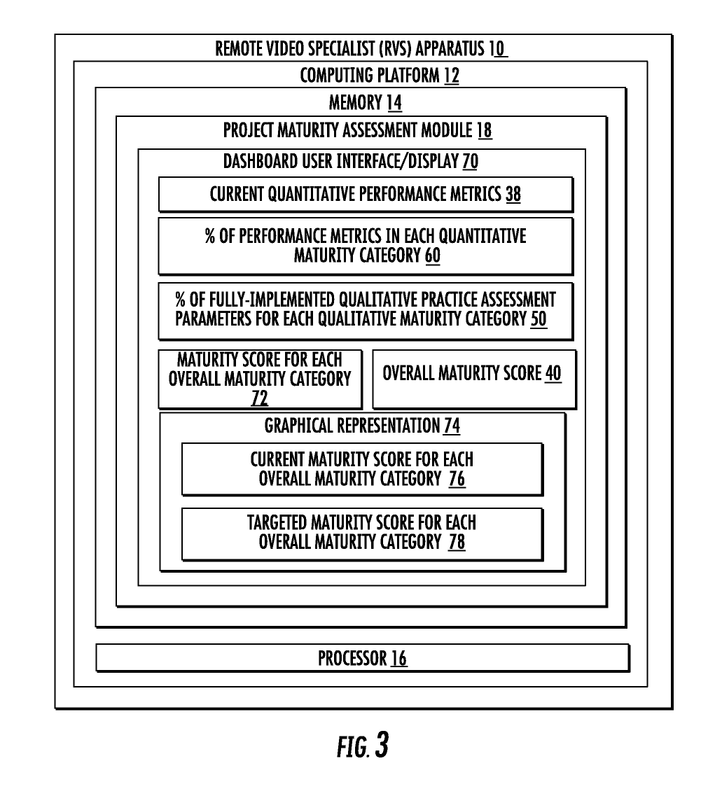

Referring to FIGS. 2 and 3, more detailed block diagrams of apparatus 10 are presented that highlight various alternate embodiments of assessing technology-related project maturity, in accordance with embodiments of the present invention. The apparatus 10 which may include more than one physical device or unit is operable to receive and execute modules, routines and applications, such as project maturity assessment module 18 and the like.

The apparatus 10 includes a computing platform 12 that can receive and execute routines and applications. The computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, the computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIGS. 2 and 3) that interfaces with any resident programs, such as project maturity assessment module 18 and the like, stored in the memory 14 of apparatus 10. Processor 16 includes various processing subsystems (not shown in FIGS. 2 and 3) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of project maturity assessment module 18 obviating the need for such applications and modules to be stored in the memory.

As previously noted in relation to FIG. 1, the memory 14 of apparatus 10 stores project maturity assessment module 18 that is configured to assess the maturity of a technology-related business project across multiple different project types/change platforms, in accordance with embodiments of the present invention. As such, project maturity assessment module 18 is configured receive a first user-input 20 that selects a project type 22, which may be a change platform, change type or the like. In response to receiving the first-user input 20, the project maturity assessment module 18 is further configured to provide a user-interface/display 24 that includes a plurality qualitative (i.e., subjective) practice assessment parameters 26 associated with the selected project type 22 and a plurality of quantitative (i.e., objective) practice assessment parameters 28 associated with the selected project type 22. In specific embodiments of the invention, as shown in FIG. 2, the qualitative practice assessment parameters 26 may be grouped according to maturity categories 42, such as a basic category 44 (defined as parameters that required by the project), an intermediate category 46 (defined as parameters that a goal of the project) and an advanced category 48 (defined as parameters that may be optionally adopted by a project). In such embodiments of the invention, each qualitative practice assessment parameters 26 resides in one maturity category 42. Additionally, in specific embodiments of the invention, certain categories of qualitative practice assessment parameters 26, such as intermediate category 46 and advanced category 48 may be configured to allow for the user to identify a parameter as a “best practice” and for allowing the user to add any recommendations or comments to a specific qualitative practice assessment parameter 26. In addition, the user-interface/display 24 may be configured to identify the process area associated with the qualitative practice assessment parameters 26.

The project maturity assessment module 18 is further configured to receive second user-inputs 30 that select an assessment level 32 for each of the qualitative practice assessment parameters 26 displayed in user-interface 24. In specific examples of the invention, the assessment levels may include, but may not be limited to, (i) fully implemented, (ii) not fully-implemented, or (iii) not applicable to the project.

In specific embodiments of the invention, the project maturity assessment module is configured to determine the percentage of the highest assessment level qualitative parameters 26 for each maturity category 42. For example, in the illustrated embodiment of FIG. 2, the percentage 50 of fully-implemented qualitative practice assessment parameters for each of maturity categories (e.g., basic, intermediate and advanced).

In addition, the project maturity module 18 is further configured to receive third user-inputs 34 that select a quantitative response 36 for each of the quantitative practice assessment parameters 26. In response to receiving the third user-inputs 34 that select the quantitative responses 36 to the quantitative practice assessment parameters 26, the project maturity assessment module is configured to determine a plurality of quantitative performance metrics 38 that are specific to the project type. In specific embodiments of the invention, the project maturity assessment module 18 is further configured to determine a quantitative maturity category 52 for each resulting quantitative performance metric 38 based on predetermined thresholds. In specific embodiments the quantitative maturity categories 52 are aligned with the qualitative maturity categories 42, such as basic category 54, intermediate category 56 and advanced category 58. In such embodiments of the invention, the project maturity assessment module 18 may be further configured to determine the percentage 60 of quantitative performance metrics in each of the quantitative maturity categories,

Moreover, in response to receiving the second and third user-inputs 30, 34 and determining the quantitative performance metrics 38, the percentage 50 of fully-implemented qualitative practice assessment parameters 26 for each qualitative maturity category 42 and the percentage 60 of quantitative performance metrics 38 in each quantitative maturity category 52, the project maturity assessment module 18 is configured to determine an overall project maturity score 40 based on the percentage 50 of fully-implemented qualitative practice assessment parameters 26 for each qualitative maturity category 42 and the percentage 60 of quantitative performance metrics 38 in each quantitative maturity category 52. In such embodiments, the project maturity assessment module 18 may further determine a maturity score/percentage for each of the categories (i.e., basic, intermediate and advanced). As previously noted, the overall maturity score 40 may be configured to indicate a category of maturity (e.g., basic, intermediate, advanced or the like) based on preconfigured thresholds, which may be based on averaging the maturity score/percentage for each of the categories (i.e., basic, intermediate and advanced).

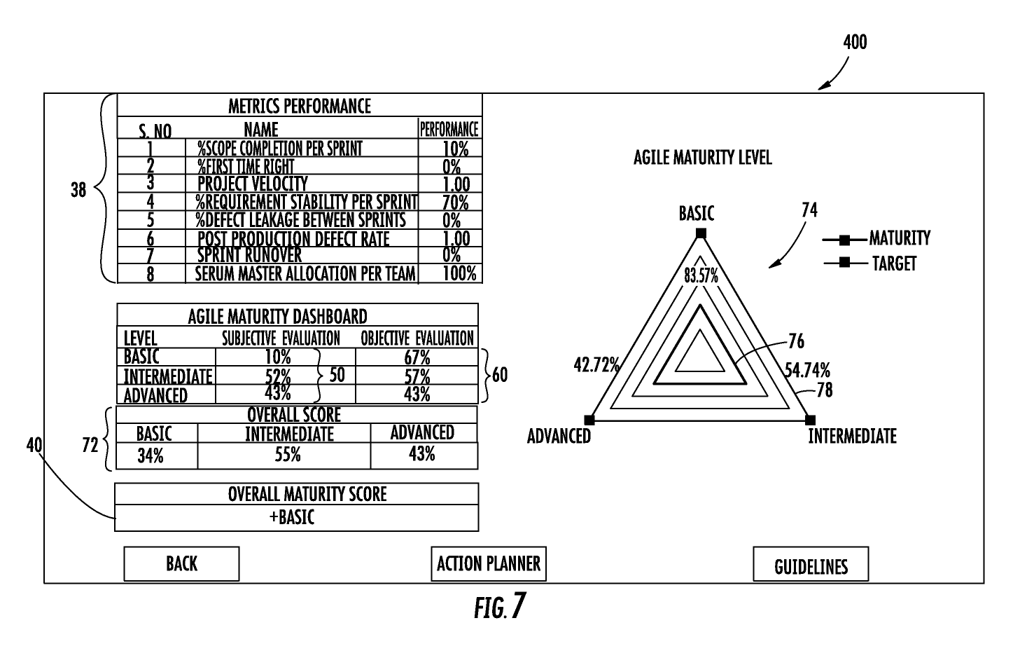

Referring to FIG. 3 a block diagram is presented of an apparatus 10 configured for providing maturity assessments for technology-related business projects, in accordance with embodiments of the present invention. Specifically, FIG. 3 highlights the ability of the project maturity assessment module 18 to present a dashboard user-interface display 70 that is configured to display various results of the maturity assessment. For a specific example of a dashboard display 70 see FIG. 7, discussed infra. In specific embodiments of the invention, the dashboard user-interface/display 70 may include the current quantitative performance metrics 38. The dashboard may display all of the performance metrics associated with a project type/change platform or the dashboard may display a select portion of the performance metrics associated with the project type/change platform. In other embodiments of the invention, the dashboard user-interface/display 70 may additionally include the percentage 60 of quantitative performance metrics in each quantitative maturity category (i.e., basic, intermediate and advanced) and the percentage 50 of fully-implemented qualitative practice assessment parameters for each qualitative maturity category (i.e., basic, intermediate and advanced). Further, the dashboard user-interface/display 70 may additionally display the maturity score/percentage 72 for each overall (i.e., the combined quantitative and qualitative) maturity category and the overall maturity score/category 40. Moreover, the dashboard user-interface/display 70 may additionally display a graphical representation 74 of the current maturity score/percentage 76 for each overall maturity category in comparison to a targeted maturity score/percentage 78 for each maturity category.

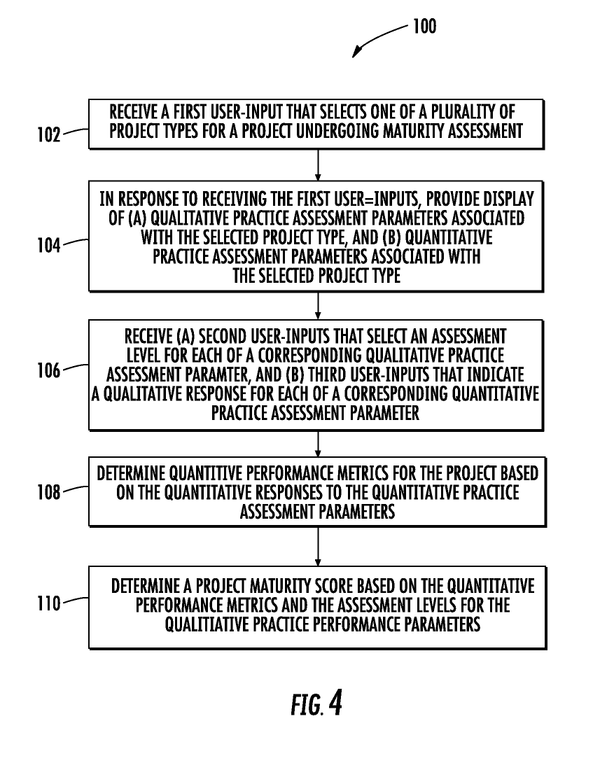

Referring to FIG. 4, a flow diagram is presented of a method 100 for assessing maturity in a technology-related business project, in accordance with embodiments of the present invention. At Event 102 a first user-input is received that selects a project type for a technology-related project undergoing maturity assessment. The project type may be a change platform, change type or the like. Examples of project types include, but are not limited to, incremental software development (e.g., agile software development), sequential design process (e.g., waterfall model), testing, production support, application security and the like.

At Event 104, in response to receiving the first-user input, a user-interface/display is provided/presented that includes a plurality qualitative (i.e., subjective) practice assessment parameters associated with the selected project type and a plurality of quantitative (i.e., objective) practice assessment parameters associated with the selected project type. In specific embodiments of the invention, the qualitative practice assessment parameters may be grouped according to maturity categories, such as a basic category (defined as parameters that required by the project), an intermediate category (defined as parameters that a goal of the project) and an advanced category (defined as parameters that may be optionally adopted by a project). In addition, the qualitative practice assessment parameters may list the process area associated with the parameter and provide for the user to identify a parameter as a best practice.

At Event 106, receive second user-inputs are received that select an assessment level for each of the qualitative practice assessment parameters and third user-inputs (or import from predetermined databases) are received that indicate a quantitative response for each of a corresponding quantitative practice assessment parameter. In specific embodiments of the invention, the assessment levels may include, but may not be limited to, (i) fully implemented, (ii) not fully-implemented, or (iii) not applicable to the project.

At Event 108, in response to receiving the third user-inputs that indicate the quantitative responses to the quantitative practice assessment parameters (or in response to importing the data from a predetermined performance database), a plurality of quantitative performance metrics are determined based on the quantitative responses/data to quantitative practice assessment parameters. The performance metrics, not unlike the quantitative practice assessment parameters, are specific to the select project type/change format.

At Event 110, in response to receiving the second and third user-inputs and determining the quantitative performance metrics, an overall (i.e., qualitative and quantitative analysis) project maturity score is determined, which is based on the quantitative performance metrics and the qualitative assessment levels. As previously noted, the overall maturity score may be configured to indicate a category of maturity (e.g., basic, intermediate, advanced or the like) based on thresholds preconfigured for the quantitative performance metrics and the qualitative assessment levels.

Referring to FIG. 5, an exemplary user-interface 200 is displayed that serves as the home page for a project maturity assessment module, in accordance with an embodiment of the present invention. The user-interface 200 is configured to allow the user to select a project type (i.e., an assessment type, change format, change type or the like). In the illustrated embodiment of FIG. 5 a drop down menu 202 is provided, which upon user selection provides for display 204 of available project type options (e.g., “project type 1”, “project type 2” . . . ). Once the user has selected a project type, the user may activate the “start the assessment” key 206 to begin the maturity assessment process. Additionally, user-interface 200 may be configured to include an abbreviated dashboard 208 that indicates results of the maturity assessment. In the illustrated example of FIG. 5, the abbreviated dashboard 208 includes the percentage 60 of performance metrics currently residing in each quantitative maturity category, the percentage 50 of fully-implemented qualitative practice assessment parameters for each qualitative maturity category, the maturity score/percentage for each overall (i.e., combined qualitative and quantitative) maturity category 72 and the overall maturity score/category 40. It should be noted that data will not be displayed in the abbreviated dashboard 208 until the maturity assessment has be undertaken.

Referring to FIGS. 6A and 6B, an exemplary user-interface 300 is shown that is displayed by the project maturity assessment module in response to a user starting the assessment (i.e., activating the “start the assessment” key 206, shown in FIG. 5). In the illustrated embodiment of FIGS. 6A and 6B, the user-interface is scrollable, such that FIG. 6A illustrates the top-most portion of the scroll and FIG. 6B illustrates the bottom-most portion of the scroll. It should be noted that certain information that would be provided in between the top-most portion of the scroll and the bottom-most portion of the scroll (e.g., certain intermediate and advanced qualitative project assessment parameters) are not shown in FIGS. 6A and 6B.

The user-interface 300 displays a plurality of qualitative practice assessment parameters 26 and quantitative practice assessment parameters 28. The qualitative practice assessment parameters 26 are grouped according to their respective qualitative maturity category: a basic category 44 (i.e., parameters that are required by the project), an intermediate category 46 (i.e., parameters that are a goal of the project) and an advanced category 48 (i.e., parameters that may optionally be adopted by the project). Moreover, the qualitative practice assessment parameters 26 provide for process area column 302 that lists a corresponding process area associated for each qualitative practice assessment parameter 26.

Additionally, the qualitative practice assessment parameters 26 provide assessment column 304 which is configured for allow a user to select or input an assessment level for each of the qualitative practice assessment parameters 26. In the illustrated embodiment of FIGS. 6A and 6B a drop down menu (not shown) is provided at each field within the assessment column to allow the user to choose from amongst various assessment level options (e.g., fully-implemented, not fully-implemented, not applicable to the project and the like). In addition, the qualitative practice assessment parameters 26 provides for best practice column 306, which provides a radio button 308 for certain categories (e.g., intermediate category and advanced category) of qualitative practice assessment parameters 26. In practice, a user may select (i.e., click-on) a radio button to indicate that a corresponding qualitative practice assessment parameter 26 is considered by the user to be a best practice within the industry or the within the business/enterprise. Additionally, the qualitative practice assessment parameters 26 provide for a recommendation/comments column 310 that allows the user to input any comments or recommendation concerning a corresponding qualitative practice assessment parameter 26.

The quantitative practice assessment parameters 28 provide for a quantitative response column 312 that allows for data imported from a predetermined performance database to be displayed or otherwise inputted (or updated/changed) by user-input.

The user-interface 300 additionally includes “submit” key 314 that is activated by the user once the assessment levels have been selected for the qualitative practice assessment parameters 26 and the quantitative responses have been inputted/changed or verified for the quantitative practice assessment parameters 28. In response to activating the “submit” key, the quantitative performance metrics are determined, the percentages of quantitative performance metrics currently residing in each quantitative maturity category are determined and the percentages of fully-implemented qualitative practice assessment parameters for each qualitative maturity category are determined. Additionally, user-interface 300 includes “home” key 316, which is activated by the user to return to the “home” page (i.e., user-interface 200 of FIG. 5).

Referring to FIG. 7, an exemplary user-interface 400 is shown that is displayed by the project maturity assessment module in response to a user submitting the assessment levels for the qualitative practice assessment parameters and the quantitative responses to the quantitative practice assessment parameters (i.e., activating the “submit” key 314 of FIG. 6B). User-interface 400 provides for display of dashboard results of the maturity assessment. Included within the dashboard display are the resulting quantitative performance metrics 38, the percentages 50 of fully-implemented qualitative practice assessment parameters for each qualitative maturity category (i.e., basic, intermediate and advanced), the percentages 60 of performance metrics in each quantitative maturity category, the maturity score/percentage for each overall (i.e., qualitative and quantitative) maturity category 72 and the overall maturity score/category 40, which is based on the average of the scores/percentages for the overall maturity categories 72 and predetermined thresholds for overall maturity score categorization (e.g., <80%=basic category, 80%-90%=intermediate category and >90%=advanced category).

User-interface 400 also includes a graphical representation 74 that compares the current maturity score/percentage 76 for each overall maturity category to the targeted maturity score/percentage 78 for each overall maturity category.

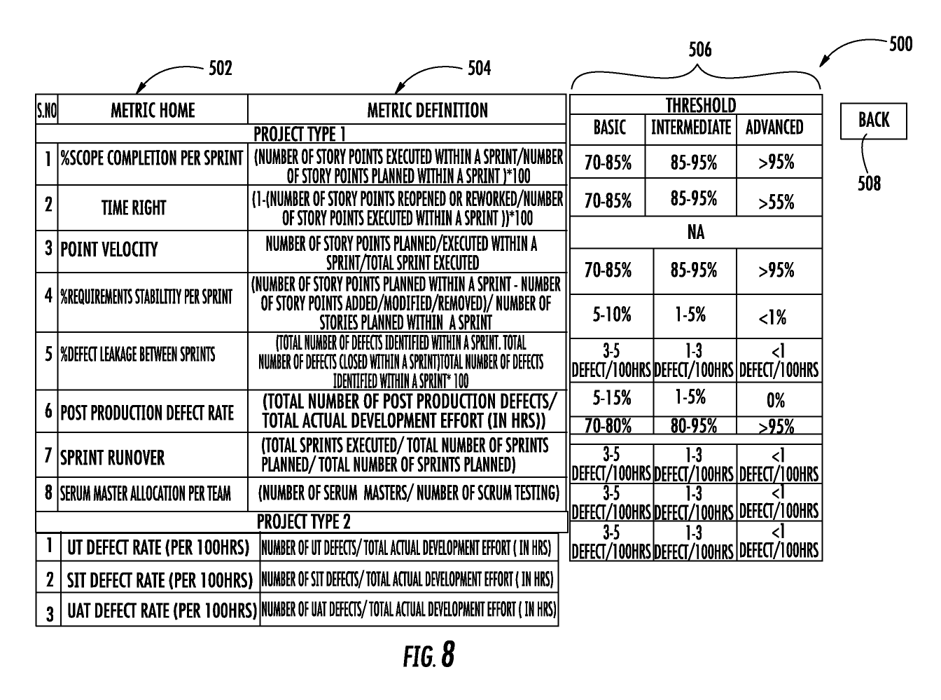

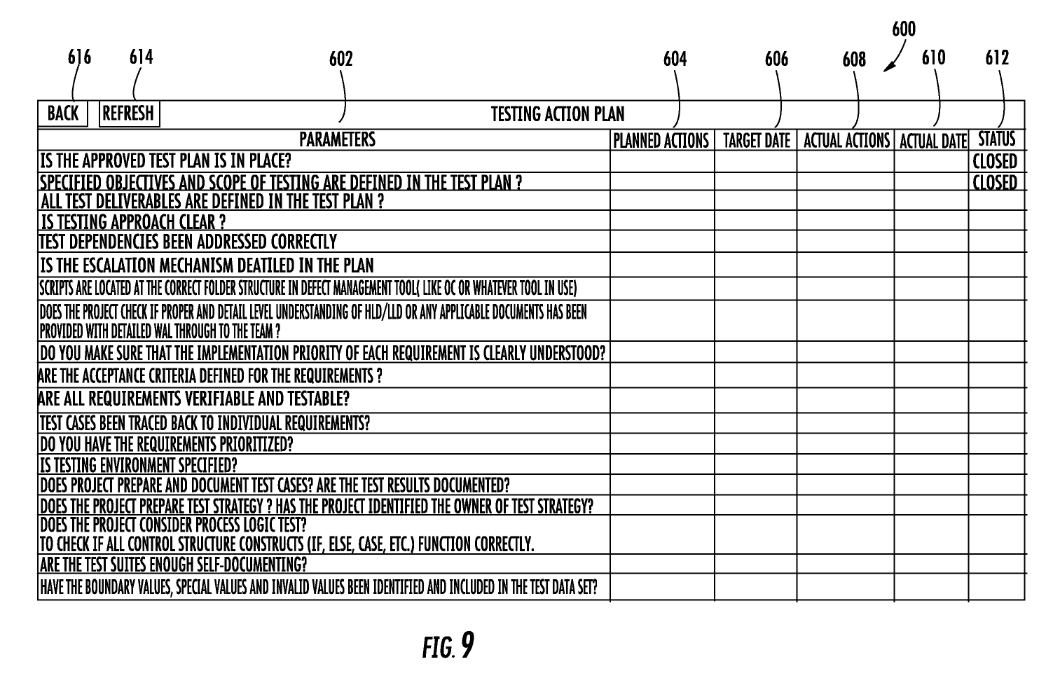

Additionally, user-interface 400 includes “back” key 402, which when activated by the user returns to the display of user-interface 300 (FIGS. 6A and 6B). In addition, user-interface 400 includes “guidelines” key 404, which when activated by the user displays a guidelines user-interface 500, shown in FIG. 8, discussed infra, and “action planning” key 406, which when activated by a user displays an action planning user-interface 600, shown in FIG. 9, discussed infra.

Referring to FIG. 8, an exemplary user-interface 500 is shown that is displayed by the project maturity assessment module in response to a user requesting guidelines (i.e., activating the “guidelines” key of user interface 400 shown in FIG. 7). The user-interface 500, which is configured to be scrollable, includes a performance metric listing/column 502 for quantitative performance metrics for each project type/change format; a performance metric definition listing/column 504, which display the formula for determining/calculating the corresponding quantitative performance metric; and threshold listing/columns 506, which lists the category thresholds for each category (basic, intermediate and advanced) that are used in determining which category a resulting quantitative performance metric resides in. Additionally, user-interface 500 includes “back” key 508, which when activated by the user returns to the display of user-interface 400 (FIG. 7).

Referring to FIG. 9, an exemplary user-interface 600 is depicted that is displayed by the project maturity assessment module in response to a user requesting corrective action planning (i.e., activating the “action planning” key 406 of user-interface 400 shown in FIG. 7). The user-interface 600 provides a qualitative practice assessment parameter listing/column 602 that provides a listing of all of the qualitative practice assessment parameter associated with the project type, as well as a planned action column 604, a target date column 606, an actual actions taken column 608, an actual date column 610 and an action status column 612. Columns 604-612 provide user entry fields for the user to input appropriate data as specified by the column heading. In addition, user-interface 600 includes “refresh” key 614, which when activated by the user serves to save the data inputted in the user entry fields. Additionally, user-interface 600 includes “back” key 616, which when activated by the user returns to the display of user-interface 500 (FIG. 8).

Thus, systems, apparatus, methods, and computer program products described above provide for assessing technology-related business project maturity across various change platforms, otherwise referred to as change types. Embodiments of the invention herein disclosed take into account both qualitative and quantitative analysis of practices within each business practice to result in a current state assessment of the project's maturity level. In this regard, embodiments of the invention leverage both industry best practices and internal (i.e., business/enterprise) as a means of assessing project maturity. Additionally opportunities for improving maturity and/or driving project efficiency are identified and exemplary practices may also be identified.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for assessing maturity of a technology-related project, the system comprising:
a computing platform having a memory and at least one processor in communication with the memory;
a project maturity assessment module stored in the memory, executable by the processor and configured to (1) receive a first user-input that selects one of a plurality of project types for a project undergoing maturity assessment, (2) in response to receiving the first user-input, provide display of (i) a plurality of qualitative practice assessment parameters associated with the selected project type and (ii) a plurality of quantitative practice assessment parameters associated with the selected project type, (3) receive a plurality of second user-inputs that select an assessment level for each of a corresponding one of the qualitative practice assessment parameters and a plurality of third user-inputs that indicate a quantitative response to each of corresponding one of the quantitative practice assessment parameters, (4) determine quantitative performance metrics for the project based on the quantitative responses to the quantitative practice assessment parameters and (5) determine a project maturity score based on the quantitative performance metrics and the assessment levels for the qualitative practice assessment parameters.

2. The apparatus of claim 1, wherein the project maturity assessment module is further configured to provide display of the plurality of qualitative practice assessment parameters, wherein each qualitative practice assessment parameter is assigned to one of a plurality of qualitative maturity categories including a basic category, an intermediate category and an advanced category, wherein the basic category includes parameters that are required by the project, the intermediate category includes parameters that are a goal of the project and the advanced category includes parameters that may optionally be adopted by the project.

3. The apparatus of claim 1, wherein the project maturity assessment module is further configured to receive the plurality of second user-inputs that select the assessment level as one of (i) fully-implemented, (ii) not fully-implemented or (iii) not applicable to the project.

4. The apparatus of claim 2, wherein the project maturity assessment module is further configured to receive the plurality of second user-inputs that select the assessment level as one of (i) fully-implemented, (ii) not fully-implemented or (iii) not applicable to the project.

5. The apparatus of claim 4, wherein the project maturity assessment module is further configured to determine a percentage of fully-implemented qualitative practice assessment parameters for each of the qualitative maturity categories.

6. The apparatus of claim 5, wherein the project maturity assessment module is further configured to determine a quantitative maturity category for each of the performance metrics, wherein the quantitative maturity categories include a basic category, intermediate category and advanced category and each category is defined by thresholds applicable to the corresponding performance metric.

7. The apparatus of claim 6, wherein the project maturity assessment module is further configured to determine a percentage of performance metrics currently determined to be residing in each of the maturity categories.

8. The apparatus of claim 7, wherein the project maturity assessment module is further configured to determine the project maturity score based on (1) the percentage of fully-implemented qualitative practice assessment parameters for each of the qualitative maturity categories, and (2) a percentage of performance metrics currently determined to be residing in each of the quantitative maturity categories.

9. The apparatus of claim 1, wherein the project maturity assessment module is further configured to generate and provide a dashboard display that includes (1) performance metric results, (2) a percentage of performance metrics currently determined to be residing in each of the quantitative maturity categories, (3) a percentage of fully-implemented qualitative practice assessment parameters for each of the qualitative maturity categories, (4) a maturity score for each overall maturity category, (5) an overall maturity score, and (6) a graphical representation of the current maturity score for each overall maturity category and a targeted maturity score for each overall maturity category.

10. A method for assessing maturity of a technology-related project, the method comprising:
receiving, by a computing device processor, a first user-input that selects one of a plurality of project types for a project undergoing maturity assessment;
in response to receiving the first user-input, providing, by a computing device processor, display of (1) a plurality of qualitative practice assessment parameters associated with the selected project type and (2) a plurality of quantitative practice assessment parameters associated with the selected project type;
receiving, by a computing device processor, (1) a plurality of second user-inputs that select an assessment level for each of a corresponding one of the qualitative practice assessment parameters and (2) a plurality of third user-inputs that indicate a quantitative response to each of a corresponding one of the quantitative practice assessment parameters;
determining, by a computing device processor, quantitative performance metrics for the project based on the quantitative responses to the quantitative practice assessment parameters; and
determining, by a computing device processor, a project maturity score based on the quantitative performance metrics and the assessment levels for the qualitative practice assessment parameters.

11. The method of claim 10, wherein providing display of the plurality of qualitative practice assessment parameters further comprises providing display the plurality of qualitative practice assessment parameters, wherein each qualitative practice assessment parameter is assigned to one of a plurality of qualitative maturity categories including a basic category, an intermediate category and an advanced category, wherein the basic category includes parameters that are required by the project, the intermediate category includes parameters that are a goal of the project and the advanced category includes parameters that may optionally be adopted by the project.

12. The method of claim 10, wherein receiving the plurality of second user-inputs that select the assessment level further comprises receiving, by the computing device processor, the plurality of second user-inputs that select the assessment level as one of (i) fully-implemented, (ii) not fully-implemented or (iii) not applicable to the project.

13. The method of claim 11, wherein receiving the plurality of second user-inputs that select the assessment level further comprises receiving, by the computing device processor, the plurality of second user-inputs that select the assessment level as one of (i) fully-implemented, (ii) not fully-implemented or (iii) not applicable to the project.

14. The method of claim 13, wherein determining the project maturity score further comprises determining, by a computing device processor, a percentage of fully-implemented qualitative practice assessment parameters for each of the qualitative maturity categories.

15. The method of claim 14, wherein determining the project maturity score further comprises determining, by a computing device processor, a quantitative maturity category for each of the performance metrics, wherein the quantitative maturity categories include a basic category, intermediate category and advanced category and each category is defined by thresholds applicable to the corresponding performance metric.

16. The method of claim 15, wherein determining the project maturity score further comprises determining, by a computing device processor, a percentage of performance metrics currently determined to be residing in each of the maturity categories.

17. The method of claim 16, wherein determining the project maturity score further comprises determining, by a computing device processor, the project maturity score based on (1) the percentage of fully-implemented qualitative practice assessment parameters for each of the qualitative maturity categories, and (2) a percentage of performance metrics currently determined to be residing in each of the quantitative maturity categories.

18. The method of claim 10, further comprising generating and providing, by a computing device processor, a dashboard display that includes (1) performance metric results, (2) a percentage of performance metrics currently determined to be residing in each of the quantitative maturity categories, (3) a percentage of fully-implemented qualitative practice assessment parameters for each of the qualitative maturity categories, (4) a maturity score for each overall maturity category, (5) an overall maturity score and (6) a graphical representation of the current maturity score for each overall maturity category and a targeted maturity score for each overall maturity category.

19. A computer program product comprising:
a non-transitory computer-readable medium comprising:
a first set of codes for causing a computer to receive a first user-input that selects one of a plurality of project types for a project undergoing maturity assessment;
a second set of codes for causing a computer to, in response to receiving the first user-input, provide display of (1) a plurality of qualitative practice assessment parameters associated with the selected project type and (2) a plurality of quantitative practice assessment parameters associated with the selected project type;
a third set of codes for causing a computer to receive (1) a plurality of second user-inputs that select an assessment level for each of a corresponding one of the qualitative practice assessment parameters and (2) a plurality of third user-inputs that indicate a quantitative response to each of a corresponding one of the quantitative practice assessment parameters;
a fourth set of codes for causing a computer to determine quantitative performance metrics for the project based on the quantitative responses to the quantitative practice assessment parameters; and
a fifth set of codes for causing a computer to determine a project maturity score based on the quantitative performance metrics and the assessment levels for the qualitative practice assessment parameters.

20. The computer program product of claim 19, further comprising a sixth set of codes for causing a computer to generate and provide a dashboard display that includes (1) performance metric results, (2) a percentage of performance metrics currently determined to be residing in each of the quantitative maturity categories, (3) a percentage of fully-implemented qualitative practice assessment parameters for each of the qualitative maturity categories, (4) a maturity score for each overall maturity category, (5) an overall maturity score and (6) a graphical representation of the current maturity score for each overall maturity category and a targeted maturity score for each overall maturity category.
